(19) United States
(12) Patent Application Publication
(10) Pub. No.: US 2015/0346974 A1
(43) Pub. Date: Dec. 3, 2015

(54) ELECTRONIC DEVICE AND DISPLAY PROCESSING METHOD

(71) Applicant: KABUSHIKI KAISHA TOSHIBA, Tokyo (JP)

(72) Inventor: Tsukasa MIKI, Tokyo (JP)

(73) Assignee: KABUSHIKI KAISHA TOSHIBA, Tokyo (JP)

(21) Appl. No.: 14/722,674

(22) Filed: May 27, 2015

(30) Foreign Application Priority Data
May 30, 2014 (JP) 2014-113201

(51) Int. Cl. G06F 3/0484

(52) U.S. Cl. CPC G06F 3/04845; G06F 3/04847; G06F 3/04842

(57) ABSTRACT

According to one embodiment, an electronic device includes a receiver and a processor. The receiver receives data related to an input operation. The processor divides a display area of a display into two or more square areas. The display area is capable of displaying at least one window. The processor displays two or more first windows on the two or more square areas, by adjusting a size or each of the two or more first windows. The processor adjusts a size and a display position of each of the two or more first windows based on an operation amount of a size-adjustment operation for adjusting a size of one of the two or more first windows, when the receiver receives data corresponded to the size-adjustment operation.

### CROSS-REFERENCE TO RELATED APPLICATIONS

This application is based upon and claims the benefit or priority front Japanese Patent Application No. 2014-113201, filed May 30, 2014, the entire contents of which are incorporated herein by reference.

### FIELD

Embodiments described herein relate generally to an electronic device and a display processing method.

### BACKGROUND

In recent years, there are sold high pixel-count displays, including 4K displays. High pixel-count displays are beginning to be used for computers, too.

There is an application program which makes use of a high pixel-count display by dividing a screen capable of displaying at least one window into two or more areas and by allowing a plurality of active application programs to exclusively use the respective areas as their respective windows.

It should be noted that in order to adjust the size of a window, fine operation is required. It is therefore quite difficult to suitably adjust the site of each of the windows displayed on the screen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an electronic device of one embodiment viewed from the front side.

FIG. 2 is an exemplary block diagram illustrating the system configuration of the electronic device of the embodiment.

FIG. 3 is an exemplary functional block diagram of a screen division utility program.

FIG. 4 is an exemplary view illustrating a state where two or more windows are arranged by the screen division utility program.

FIG. 5 is an exemplary view for explaining the operation of bringing the screen division utility program to a screen division setting mode.

FIG. 6 is an exemplary view illustrating a statue where a transparent window is displayed over the two or more windows by the screen division utility program.

FIG. 7 is an exemplary view for explaining the operation for changing the size of a certain window.

FIG. 8 is an exemplary view illustrating a state where all the windows are changed in their respective sizes and display positions by the operation illustrated in FIG. 7.

FIG. 9 is an exemplary view illustrating a state where a list is displayed on the transparent window by the screen division utility program.

FIG. 10 is an exemplary view illustrating a state where display windows having been changed by the screen division utility program are displayed.

FIG. 11 is an exemplary flowchart illustrating a processing procedure of the screen division utility program.

FIG. 12 is an exemplary flowchart illustrating a portion of a processing procedure of the screen division utility program when it is in a screen division setting mode.

FIG. 13 is an exemplary flowchart illustrating a further portion of the processing procedure of the screen division utility program when it is in a screen division setting mode.

### DETAILED DESCRIPTION

Various embodiments will be described hereinafter with reference to the accompanying drawings.

In general, according to one embodiment, an electronic device includes a receiver and a processor. The receiver is configured to receive data related to an input operation. The processor is configured to divide a display area of a display into two or more square areas. The display area is capable of displaying at least one window. The processor is configured to display two or more first windows on the two or more square areas, by adjusting a size of each of the two or more first windows. The processor is configured to adjust a size and a display position of each of the two or more first windows based on an operation amount of a size-adjustment operation for adjusting a size of one of the two or more first windows, when the receiver receives data corresponded to the size-adjustment operation.

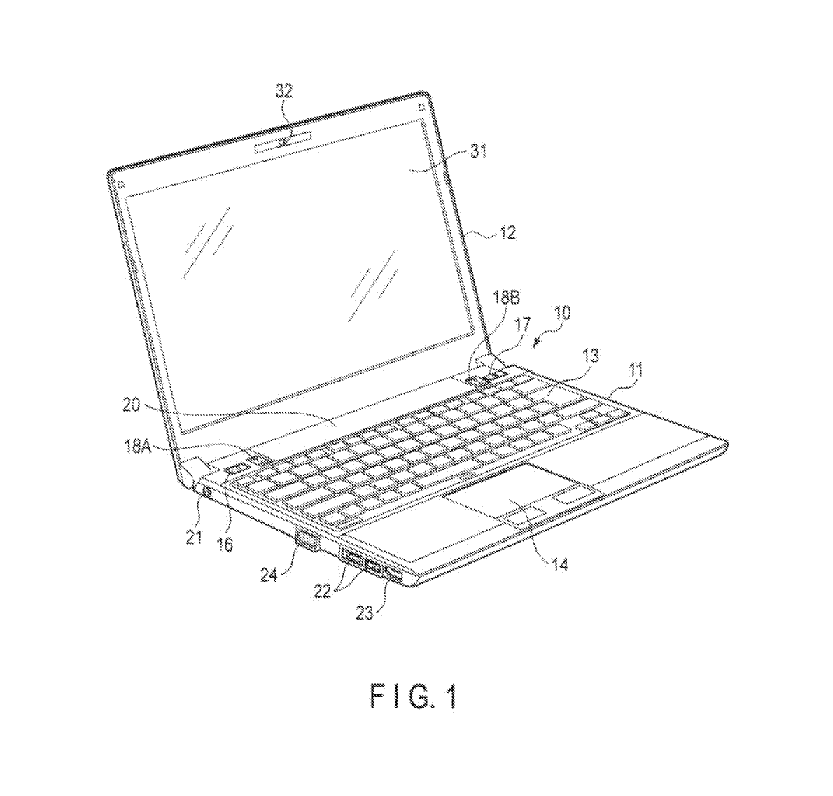

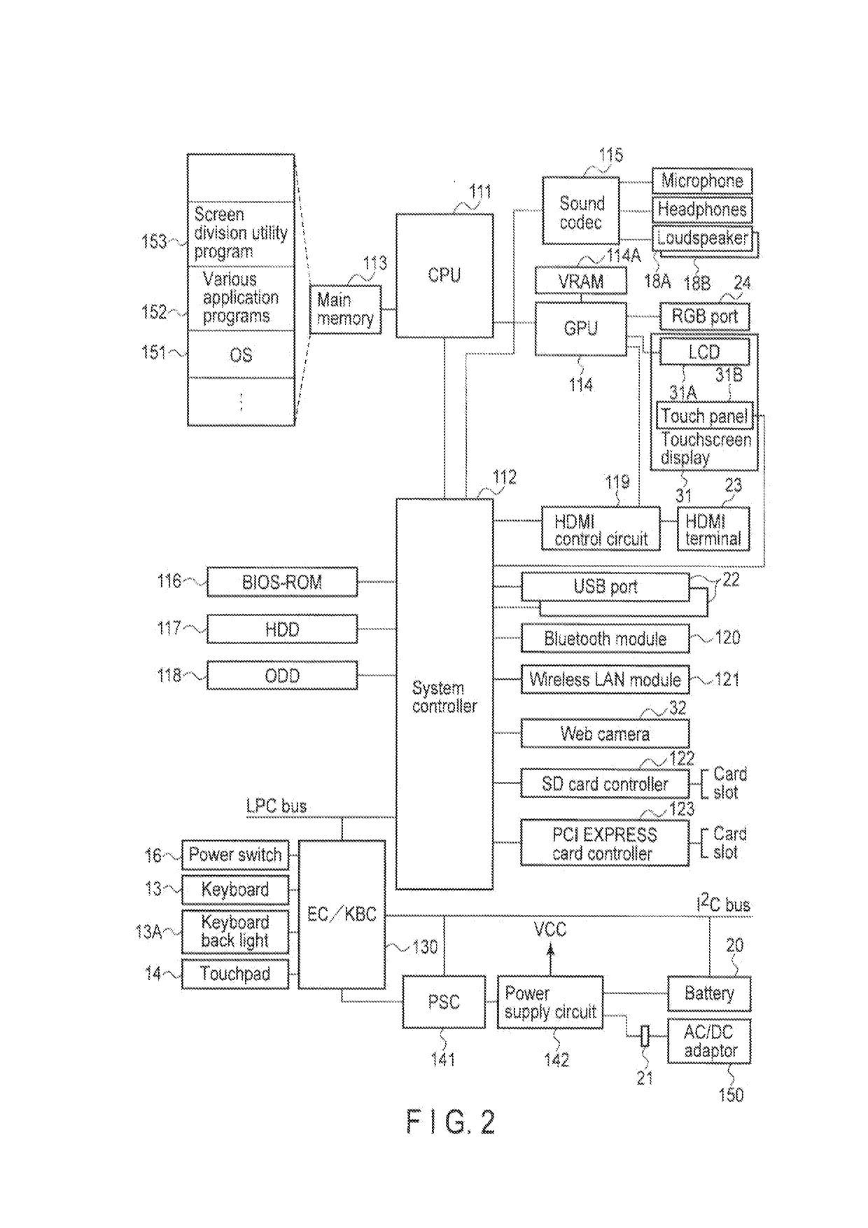

First, the structure of an information processing device in one embodiment will be explained with reference to FIG. 1 and FIG. 2. The information processing device may be realized as a notebook portable personal computer, for example.

FIG. 1 is an exemplary perspective view of a notebook computer 10 viewed from the front side in a state where a display unit is opened. The computer 10 is made to receive power from a battery 20. The computer 10 comprises a computer body 11 and a display unit 12. The display unit 12 comprises a touchscreen display. The touchscreen display comprises a flat panel display (for example, a liquid crystal display [LCD]) and a touch panel. The touch panel is provided to cover the screen of the LCD. The touch panel is made to locate a touch position on the touchscreen display whenever a user's finger or pen touches the touchscreen display. Furthermore, a camera (webcam) 32 is arranged in the upper end of the display unit 12.

The display unit 12 is attached to the computer body 11 in such a manner that it freely rotates between an open position where the upper surface of the computer body 11 is exposed and a closed position where the upper surface of the computer body 11 is covered with the display unit 12. The computer body 11 comprises a thin box shaped case. A keyboard 13, a touchpad 14, a power switch 16 for powering up or off the computer 10, some function buttons 17, and loudspeakers 18A and 18B are arranged on the upper surface of the computer body 11.

The computer body 11 comprises a power connector 21. The power connector 21 is at one side, for example the left hand side, of the computer body 11. An external power unit is removably connected to the power connector 21. An AC/DC adaptor may be used as the external power unit. The AC/DC adaptor changes commercial power (AC power) into DC power.

The battery 20 is removably attached to, for example, the back end portion of the computer body 11. The battery 20 may be a battery built in the computer 10 in advance.

The computer 10 is driven with power from the external power unit or power from the battery 20. If the external power unit is connected to the power connector 21 of the computer 10, the computer 10 will be driven with the power from the external power unit. In addition, the power from the external power unit is else used to charge the battery 20. During the period when the external power unit is not connected to the power connector 21 of the computer 10, the computer 10 is driven with the power from the battery 20.

Furthermore, some USB ports 22, a high Definition Multimedia Interface (HDMI (registered trademark)) output socket 23, and en RGB port 24 are provided to the computer body 11.

FIG. 2 illustrates the system configuration of the computer 10. The computer 10 comprises a touchscreen display 31, a CPU 111, a system controller 112, a main memory 113, a graphics processing unit (GPU) 114, a sound codec 115, a BIOS ROM 116, a hard disk drive (HDD) 117, an optical disc drive (ODD) 118, Bluetooth (registered trademark) module 120, a wireless LAN module 121, an SD card controller 122, a PCI EXPRESS card controller 123, an embedded controller/keyboard controller IC (EC/KBC) 130, a keyboard back light 13A, a power source controller (FSC) 141, a power supply circuit 142, etc.

The CPU 111 is a processor which controls operation of each component or the computer 10. The CPU 111 performs various pieces of software loaded to the main memory 113 from the HDD 117, which is used as a storage apparatus. The various pieces of software include an operating system (OS) 151, various application programs 152, and a screen division utility program 153.

Moreover, the CPU 111 performs a basic input/output system (BIOS) stored in the BIOS ROM 116, which is a nonvolatile memory. The BIOS is a system program for hardware control.

The GPU 114 is a display controller which controls an LCD 31A used as a display monitor of the computer 10. The GPU 114 generates from the display data stored in a video memory (VRAM) 114A a display signal (LVDS signal) which should be supplied to the LCD 31A. Furthermore, the GPU 114 generates from the display data an analog RGB signal and an HDMI video signal. The analog RGB signal is supplied through the RGB port 24 to an external display. The HDMI output socket 23 outputs the HDMI video signal (non compressed digital video signal) and a digital audio signal to the external display by a single cable. An HDMI control circuit 119 is an interface for output ting the HDMI video signal and the digital audio signal through the HDMI output socket 23 to the external display.

The system controller 112 is a bridge device which connects the CPU 111 and each component. The system controller 112 includes a serial ATA controller for controlling the hard disk drive (HDD) 117 and the optical disc drive (ODD) 118. Furthermore, the system controller 112 performs communication with each device on a low pin count (LPC) bus.

The EC/KBC 130 is connected to the LPC bus. The EC/KBC 130, the power source controller (PSC) 141, and the battery 20 are mutually connected through a serial bus like I²C bus.

The EC/KBC 130 is a power management controller for performing control of power of the computer 10. For example, it is realized as a single-chip microcomputer including a keyboard controller which controls the keyboard (KB) 13, the touchpad 14, etc. The EC/KBC 130 comprises a function of powering up or off the computer 10 in response to the operation of the power switch 16 conducted by a user. The control of powering up or off the computer 10 is powered by collaboration operation between the EC/KBC 130 and the power source controller (PSC) 141. Upon reception of an ON signal transmitted from EC/KBC 130, the power source controller (PSC) 141 controls the power supply circuit 142 and powers up the computer 10. Moreover, upon reception of an OFF signal transmitted from EC/KBC 130, the power source controller (PSC) 141 controls the power supply circuit 142 and powers off the computer 10. The EC/KBC 130, the power source controller (PSC) 141, and the power supply circuit 142 may operate with power from the battery 20 or the AC/DC adaptor 150 even while the computer 10 is powered off.

Furthermore, the EC/KBC 130 can turn on or off the keyboard back light 13A arranged at the back of the keyboard 13. The EC/KBC 130 is furthermore connected to a panel opening and closing switch 131, which is configured to detect the display unit 12 to be opened or closed. When the panel opening and closing switch 131 detects the display unit 12 being opened, the EC/KBC 130 may power up the computer 10.

The power supply circuit 142 generates power (operating power), which should be supplied to each component, using the power from the battery 20 or the power from AC/DC adapt tor 130 connected to the computer body 11 as an external power supply.

It should be noted that the operating system serving as an acquisition module acquires data in response to the user's operation of the touchscreen display 31 or the touchpad 14, each being an input unit. The operating system passes an event according to the acquired data to the screen division utility program 133, which allows the screen division utility program 153 to acquire the event in response to the user's operation.

The screen division utility program 153 is a program which virtually divides into two or more square areas the desktop area of the LCD31A where at least one window can be displayed, assigns to the respective square areas two or more windows corresponding to the applications currently performed by the computer 10, displays them there, and performs processing of covering the whole desktop area with two or more windows.

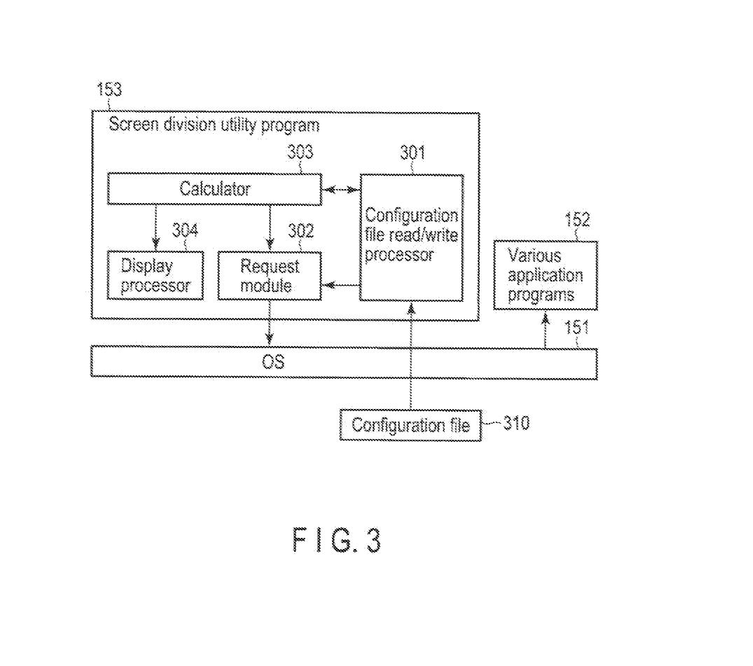

FIG. 3 is an exemplary functional block diagram of the screen division utility program 153.

As illustrated in FIG. 3, the screen division utility program 153 comprises a configuration file read/write processor 301, a request module 302, a calculator 303, a display processor 304, etc.

The configuration file read/write processor 301 performs processing which reads a configuration file 310 or changes the setup described in the configuration file 310. The configuration file 310 comprises square area data which specifies a position and a size for each of the two or more square areas and data which associates every one of the square areas with a corresponding one of the applications.

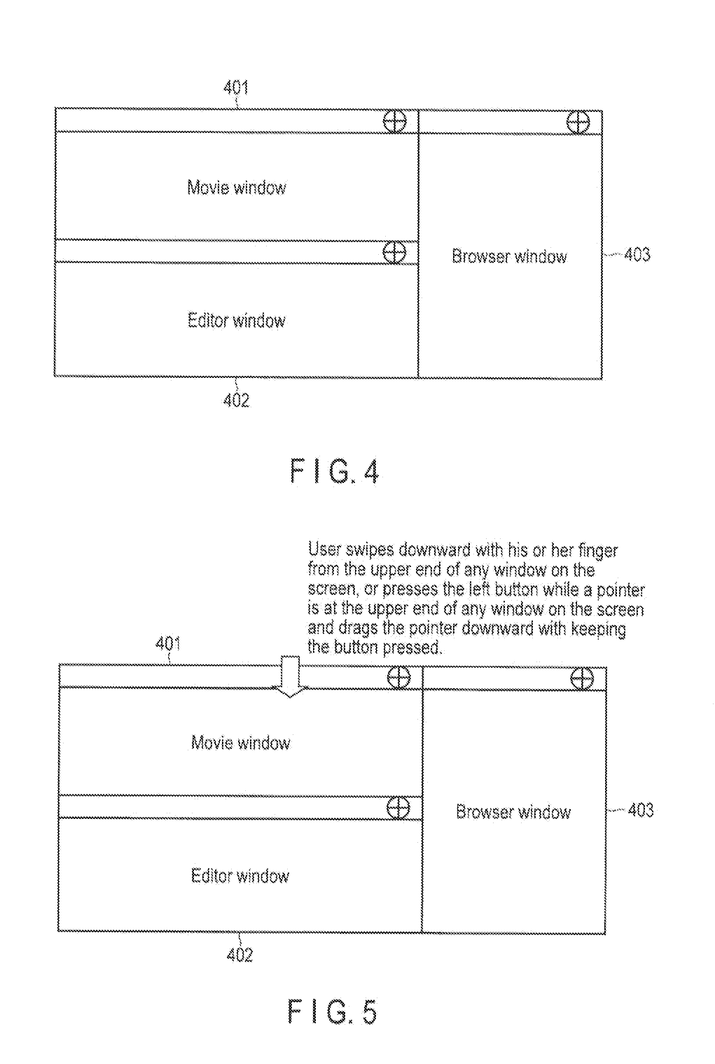

Based on the read configuration file 310, the request module 300 serving as a first display processor performs processing for displaying at each square area an associated one of the two or mote first windows that corresponds to one of the two or more first applications of at least a part of the various applications. The request module 302 requests the operating system 151 to display a window of an application related with a square area in accordance with the position and size of the square area. The operating system 131 displays windows according to the requests, as illustrated in FIG. 4, and notifies the sizes requested from the request module 302 to the two or more first applications 152A. The two or more first applications 152A perform their respective display processes according to the respective notified sizes.

As illustrated in FIG. 4, what are displayed as the two or more first windows are a movie window 401 displayed by a movie application, an editor window 402 displayed by an editor application, and a browser window 403 displayed by a browser application.

As illustrated in FIG. 5, when the user swipes downward with his or her finger from the upper end of any window on the screen, or when the user presses the left button of the touchpad 14 while a pointer is at the upper end of any window on the screen and drags the pointer downward with keeping the button in the pressed state, the screen division utility program 153 will be placed in a screen division setting mode for changing the size of the window specified by the finger or the pointer.

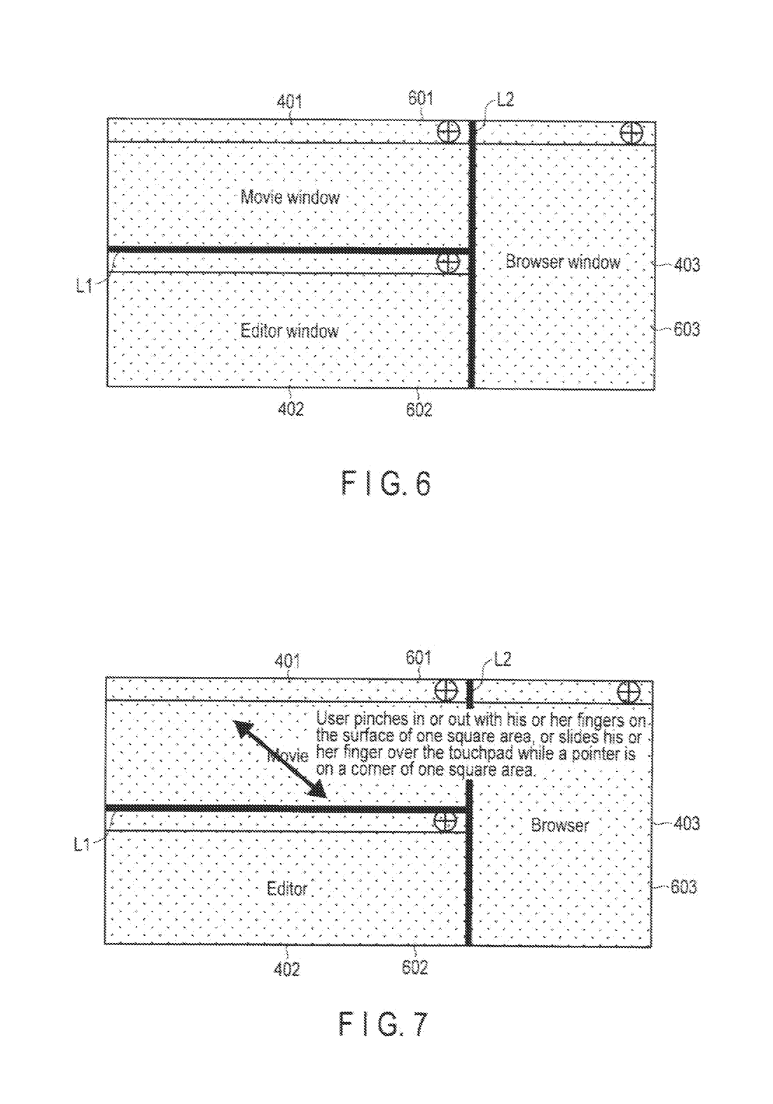

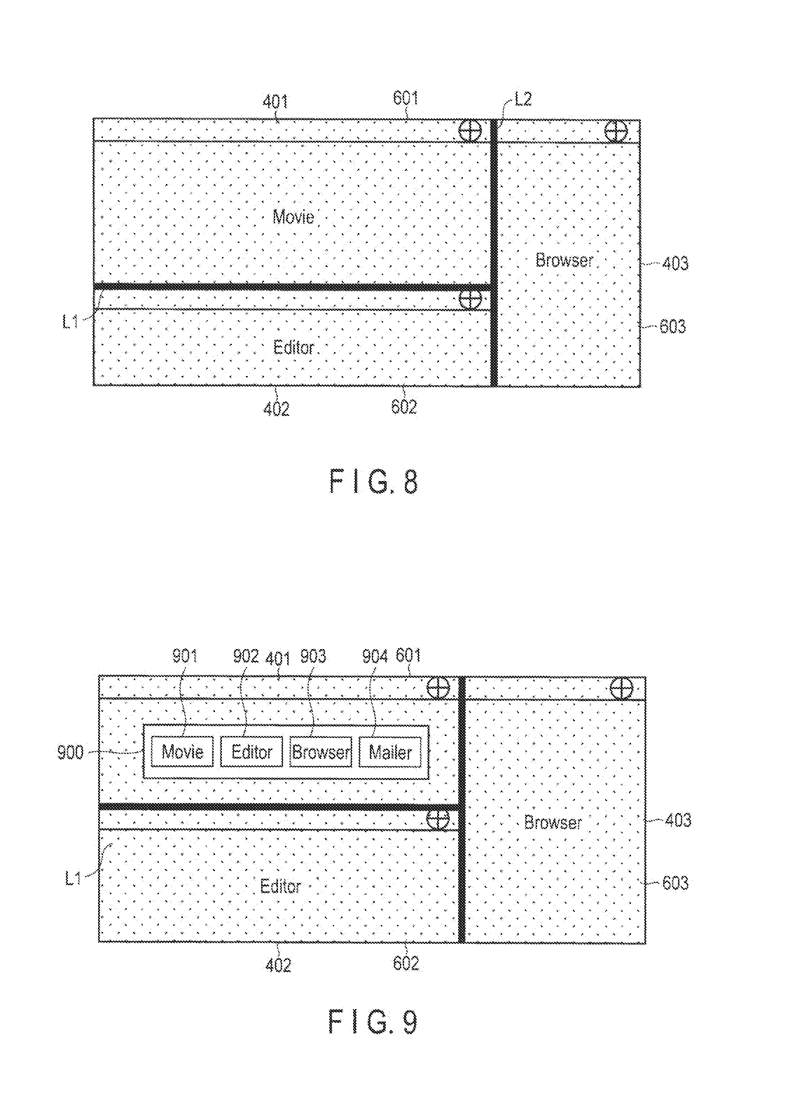

In the screen division setting mode, the display processor 304 displays a translucent window 600 covering all the windows 401, 402 and 403, as illustrated in FIG. 6. The display processor 304 displays on the translucent window 600 boundary lines L1 and L2 which indicate the boundaries of the square areas occupied by the corresponding windows.

When the user performs operation to change the site of one window among the windows 401, 402 and 403 in the screen division setting mode, the calculator 303 calculates the size and position of each square area according to the operation amount. More specifically, when the user performs a pinch in or a pinch out gesture with his or her fingers on the surface of a certain square area or when the user slides his or her finger over the end of touchpad 14 towards an upper or a lower while a pointer is on a certain square area, as illustrated in FIG. 7, the calculator 303 calculates the size and position of each square area according to the pinch in or pinch out amount executed by the fingers or the sliding amount and sliding direction of the finger.

The display processor 304 serving as a second display processor changes the display positions of the boundary lines L1 and L2 according to the site and position of each square area calculated by the calculator 303.

The request module 302 requests the operating system 131 to change the size and display position of each of the windows 401, 402 and 403 according to the size and position of a corresponding one of the square areas calculated by the calculator 303. The operating system 151 notifies the applications corresponding to the windows 401, 402 and 403 to change the respective sizes. Since each application performs processing for displaying its own window according to the notified size, each of the windows 401, 402 and 403 changes in sire and display position as illustrate in FIG. 6.

When the user touches a certain square area for a long time, or when the user clicks the right button of the touchpad 14 while a pointer is on a certain square area, the display processor 304 serving as the second display processor displays a list of all the windows in the square area in question. All the windows are windows of the applications that can display their respective windows on the screen, among the applications currently performed by the computer 10. FIG. 9 is an exemplary view illustrating a case where the user touches a square area 601 for a long time or clicks the right button of the touchpad 14 while a pointer is on the square area 601. As illustrated in FIG. 9, a list 900 is displayed on the square area 601. Movie items 901 corresponding to the movie window 401, editor items 902 corresponding to the editor window 402, browser items 903 corresponding to the browser window 403, and mailer items 904 corresponding to a mailer window which may be displayed by a mailer application are displayed in the list.

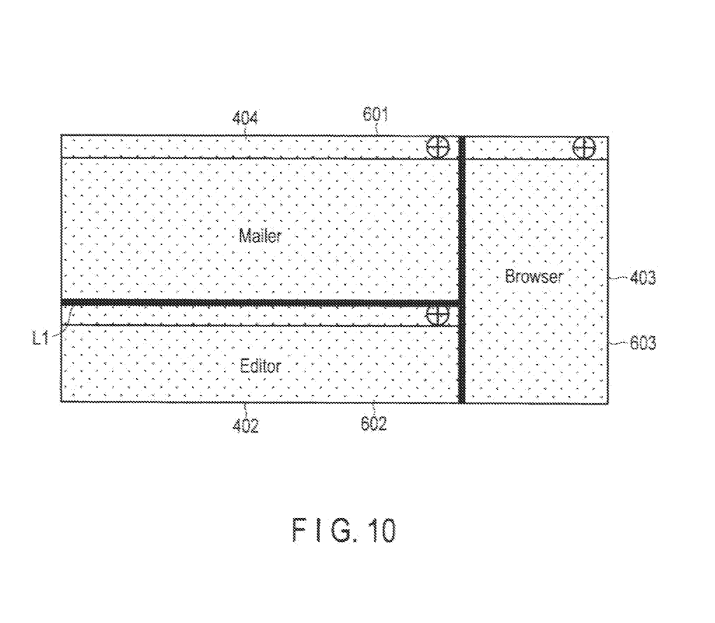

When the mailer items 904 in the list 900 is touched, or when the left button is clicked while a pointer is on the mailer items 904 in the list 900, the request module 302 requests the operating system 151 to minimize the window 401 and instead to display at the square area 601 an e mail window which is adjusted in position and size to suitably fit in the square area 601. The operating system 151 notifies the mailer application of a size. Since the mailer application performs processing for displaying a window which has the notified size, the mailer window 404 is displayed instead of the window 401 which was displayed under the list 900, as illustrated in FIG. 10.

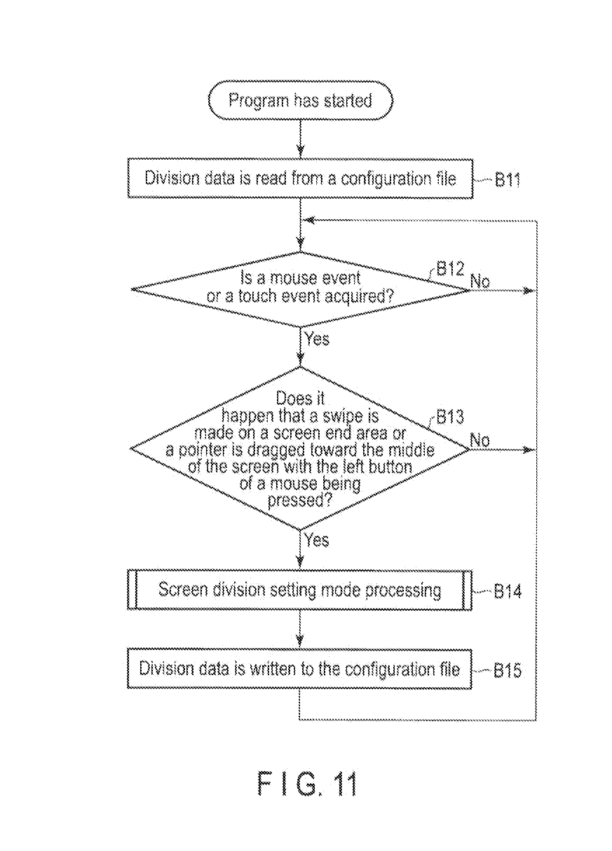

FIG. 11 is an exemplary flowchart illustrating the processing procedure which the screen division utility program 153 executes.

The configuration file reed/write processor 301 reads the configuration file 310, which includes division data, after the screen division utility program 153 has started (Block Bill). According to the configuration file, the request module 302 performs processing for displaying a window on each of the two or more square areas, as illustrated in FIG. 4.

The screen division utility program 153 determines whether a mouse event or a touch event is acquired (Block B12). When a mouse event or a touch event is acquired (Yes in Block B12), and when the mouse event is a swipe made on a screen end area or the touch event is a drag of a pointer toward the middle of the screen while the left button of the touchpad 14 (or a mouse) is pressed, as illustrates in FIG. 5 (Yes in Block B13), the screen division utility program 153 is brought to screen division setting mode processing (Block B14). After the screen division sorting mode processing has been completed, the configuration file read/write processor 301 writes division data to the configuration file 310.

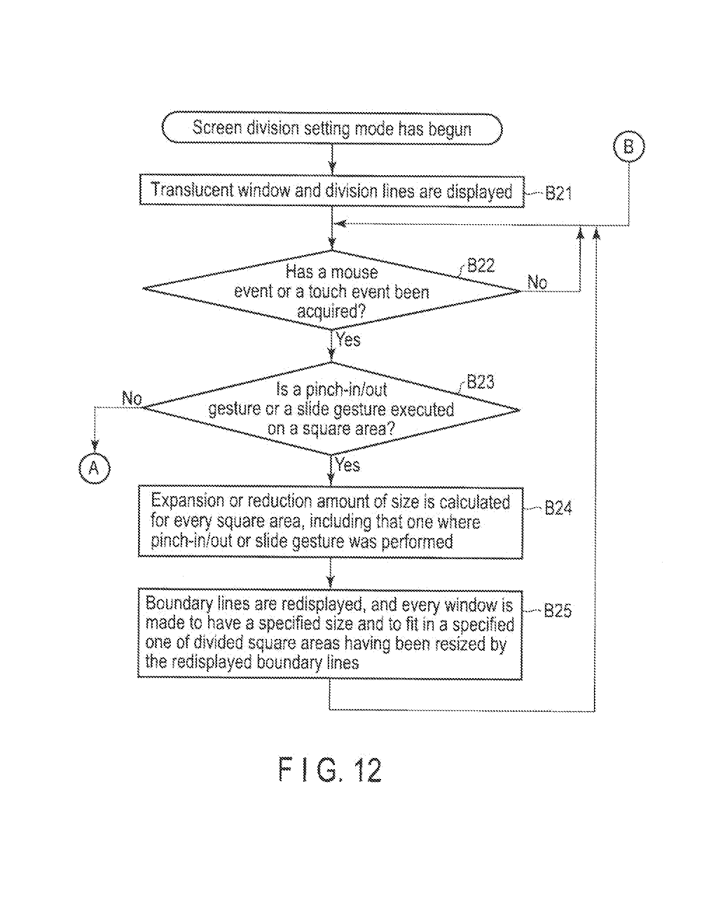

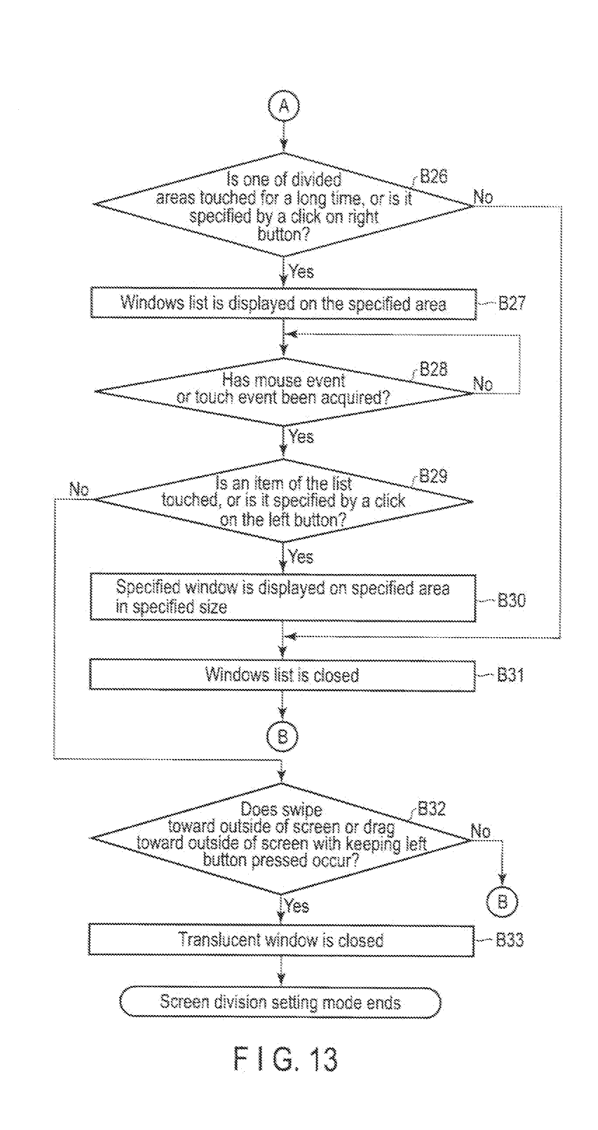

FIG. 12 and FIG. 13 are individually an exemplary flowchart illustrating a procedure which the screen division utility program 153 follows while it is in a screen division setting mode.

At the time of screen division setting mode processing, the display processor 304 displays the translucent window 600 spreading over the whole screen, as illustrated in FIG. 6 (Block B21). The display processor 304 also displays the boundary lines L1 and L2 based on the present division data (Block B21).

The screen division utility program 153 periodically determines whether a mouse event or a touch event has been acquired (Block B22). When a mouse event or a touch event is acquired (Yes in Block B22), and when a pinch in/out gesture or a slide gesture is executed on a square area (Yes in Block B23), the calculator 303 calculates, based on the operation amount or the pinch in/out or slide gesture, the enlargement or reduction amount of the size of every square area displayed on the display area of the display, including the square area where the pinch in/out or slide gesture was performed (Block B24). The calculator 303 updates division data according to the enlargement or reduction amount calculation results, and the display processor 304 redisplays the boundary lines according to the updated division data (Block B25). The request module 302 also requests the operating system 151 to change the display of each window according to a corresponding one of the resized square areas. Each window will be thus changed in size and position (Block B25).

The redisplaying the boundary lines and the changing the display of each window are performed in parallel. Therefore, it seems to a user that the boundary lines move in real time and that the windows are changed in size and position according to the user's operation in real time.

When a mouse event or a touch event is acquired (Yes in Block B23), and when the user touches one of the divided areas for a long time or clicks the right button of the touchpad while a pointer is on the divided areas (Yes in Block B26), the display processor 304 displays the list of all the windows on the divided area (Block B27). The screen division utility program 153 determines whether a mouse event or a touch event has been acquired (Block B28). When the mouse event or the touch event is acquired (Yes in Block B28), and when a touch on an item of the list is carried out or a click operation of the left button while a pointer is on an item of the list is performed (Yes in Block 829), the request module 302 performs processing for displaying on the divided area the window corresponding to the specified items (Block B30).

When a mouse event or a touch event is acquired (Yes in Block B28), and when the mouse event or the touch event is a swipe toward the outside of the screen or a drag toward the outside of the screen with keeping the left button in a pressed state (Yes in Block B32), the display processor 304 closes the translucent window (Block B30). The screen division utility program 153 ends the screen division setting mode.

In the above mentioned embodiment, when the operation of adjusting the size of the window 401 is performed by the user at the window 401 among the windows 401, 402 and 403, all the windows 401, 402 and 403 are adjusted in their respective sizes and display positions in real time according to the operation amount of the adjusting operation made to the single window. Therefore, it is easy for the user to adjust all the windows displayed on the screen.

It should be noted that the various procedures of the embodiment can be reduced to a computer program, which makes it possible to easily accomplish the same effects as the embodiment only by installing the computer program in a computer through a computer readable storage medium storing the computer program so as to cause the computer to execute the installed computer program.

The various modules of the systems described herein can be implemented as software applications, hardware and/or software modules, or components on one or more computers, such as servers. While the various modules are illustrated separately, they may share some or all or the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a received configured to receive data related so an input operation; and
processor configured to:
divide a display area of a display into two or more square areas, the display area being capable of displaying at least one window; and
display too or more first windows on the two or more square areas, by adjusting a size of each of the two or more first windows,
wherein the processor is configured to adjust a size and a display position or each of the two or more first windows based on an operation amount of a size-adjustment operation for adjusting a size of one of the two or more first windows, when the receiver receives data corresponded to the size-adjustment operation.

2. The device of claim 1, wherein the processor is configured to:
calculate an expansion amount or a reduction amount of each of the two or more first windows based on the operation amount; and
display a translucent window over the two or more first windows and lines indicative of boundaries of the two or more square areas, and
the processor is configured to change a display position of each of the lines based on the calculated expansion amount or tire reduction amount.

3. The device of claim 2, wherein the processor is configured to request an operating system executed by the electronic device to change a size and a display position of each of the windows, based on the calculated expansion amount or reduction amount.

4. The device of claim 1, wherein the processor is configured to:
display a list of two or more second windows comprising the two or more first windows, when the receiver receives data corresponded to a selection-operation for selecting one first window out of the two or more first windows, and
display a third window instead of the selected first window, when the receiver receives data corresponded to a selection-operation for selecting one second window out of the two or more second windows, the third window being a selected second window.

5. The device of claim 4, wherein the processor in configured to display the list on the selected first window.

6. A display processing method comprising:
dividing a display area of a display into two or more square areas, the display area being capable of displaying at least one window;
displaying two or more first windows on the two or more square areas, by adjusting a size of each of the two or more first windows; and
adjusting a size and a display position of each of the two or more first windows based on an operation amount of a size-adjustment operation for adjusting a size of one of the two or more first windows, when the receiver receives data corresponded to the size-adjustment operation.

7. A non-transitory computer readable medium having stored thereon a computer program which is executable by a computer, the computer program controlling the computer to execute functions of:
dividing a display area of a display into two or more square areas, the display area being capable of displaying at least one window;
displaying two or more first windows on the two or more square areas, by adjusting a size of each of the two or more first windows; and
adjusting a size and a display position of each of the two or more first windows based on an operation amount of a size-adjustment operation for adjusting a size of one of the two or more first windows, when the receiver receives data corresponded to the size-adjustment operation.
